(19) United States
(12) Patent Application Publication
(10) Pub. No.: US 2012/0093240 A1
(43) Pub. Date: Apr. 19, 2012

(54) INTERFERENCE DETECTION IN A POWERLINE COMMUNICATION NETWORK

(75) Inventors: William J. McFarland, Los Altos, CA (US); Srinivas Katar, Gainesville, FL (US); Lawrence W. Yonge, III, Ocala, FL (US)

(73) Assignee: Atheros Communications, Inc., San Jose, CA (US)

(21) Appl. No.: 13/008,554

(22) Filed: Jan. 18, 2011

Related U.S. Application Data
(60) Provisional application No. 61/295,867, filed on Jan. 18, 2010.

(51) Int. Cl. H04B 3/00

(52) U.S. Cl. 375/257

(57) ABSTRACT

A powerline communication (PLC) network can be subject to noise/interference resulting in loss of throughput and data corruption for PLC devices connected to the PLC network. A powerline interference analyzer can be implemented in the PLC network for detecting sources of the noise. The powerline interference analyzer can determine powerline network noise characteristics that are representative of noise on the PLC network and can analyze the powerline network noise characteristics to determine one or more noise patterns. The noise patterns can be compared with a plurality of predefined noise signatures that are representative of corresponding each of a plurality of noise sources. Consequently, at least one noise source that is associated with the noise patterns can be identified from the plurality of the noise sources.

### BACKGROUND

Embodiments of the inventive subject matter generally relate to the field of communication networks and, more particularly, to interference detection in a powerline communication network.

Electric transmission and distribution lines are typically used for providing electric power from generators to buildings, residences, and other components of a city's infrastructure. Electric power is transmitted over the transmission lines at a high voltage, and distributed to buildings and other structures at much lower voltages using electric power lines. Besides providing electric power, electric power lines can also be used to implement powerline communications within buildings and other structures. Powerline communications provides a means for networking electronic devices together and also connecting the electronic devices to the Internet. For example, HomePlug® devices can be used for wired broadband networking using IEEE P1901 standards for broadband over powerline communication. However, the powerline communication networks can be subject to interference, which can corrupt data packet exchanged via the powerline communication network.

### SUMMARY

Various embodiments for detecting interference in a powerline communication network are disclosed. In one embodiment, a powerline interference analyzer of a powerline communication network determines powerline network noise characteristics that are representative of noise on the powerline communication network. One or more noise patterns are determined based on analyzing the powerline network noise characteristics. The one or more noise patterns are compared with a plurality of predefined noise signatures stored in the powerline interference analyzer that are representative of corresponding each of a plurality of noise sources. At least one noise source that is associated with the one or more noise patterns is identified from the plurality of the noise sources stored in the powerline interference analyzer based on comparing the one or more noise patterns with the plurality of predefined noise signatures. An indication of the at least one noise source, from the plurality of the noise sources, that is associated with the one or more noise patterns is presented.

### BRIEF DESCRIPTION OF THE DRAWINGS

The present embodiments may be better understood, and numerous objects, features, and advantages made apparent to those skilled in the art by referencing the accompanying drawings.

FIG. 1 is an example block diagram illustrating a mechanism for identifying noise sources in a powerline communication network;

FIG. 2 is a flow diagram illustrating example operations for determining noise sources in a powerline communication network based on analyzing powerline network noise characteristics;

FIG. 3 is a flow diagram illustrating example operations for determining noise sources in a powerline communication network based on analyzing signal characteristics of powerline communication signals; and

FIG. 4 is a block diagram of one embodiment of an electronic device including a mechanism for interference detection in a powerline communication network.

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. For instance, although some embodiments refer to detecting interfering devices in a powerline network comprising powerline communication (PLC) devices implementing HomePlug AV communications, embodiments are not so limited. In other embodiments, the techniques for detecting interfering devices can be implemented in any suitable powerline network. For example, techniques for detecting interfering devices can be implemented in a powerline network comprising both G.HN powerline devices and HomePlug AV powerline devices. In other instances, well-known instruction instances, protocols, structures, and techniques have not been shown in detail in order not to obfuscate the description.

Broadband over powerline communication (PLC) focuses on enabling broadband communication via existing powerline networks (e.g., power lines in homes and buildings). However, since powerline networks were originally designed for power transfer, powerline networks are subject to time-varying and frequency-varying noise sources. For example, energy saving devices, lighting devices, small appliances, and various other electronic devices can introduce noise on the powerline network and can corrupt data packets transmitted for broadband over powerline communication. Powerline networks may also not have controlled impedances and the impedance seen by different powerline communication devices (“PLC devices”) may vary depending on a number and type of other electronic devices connected to the powerline network and the position (e.g., a powerline socket) of the electronic devices within the powerline network. In some implementations, powerline devices may also modulate the impedance of the powerline network, causing the impedance to vary from one powerline outlet to another, thus compromising communication performance of the PLC devices on the powerline network (“PLC performance”).

A powerline interference analyzer can be implemented in the powerline network to detect the presence of powerline and non-powerline devices (“noise sources”) that can cause noise/interference on the powerline network. The powerline interference analyzer can analyze a time-domain variation of the noise encountered by the powerline network, a frequency-domain variation of the noise encountered by the powerline network, and/or variation of received PLC signal characteristics (e.g., signal to noise ratio (SNR)) to determine noise characteristics associated with the powerline network. Furthermore, the powerline interference analyzer can analyze the noise characteristics associated with the powerline network and identify one or more noise sources that are likely impairing the PLC performance based on a noise signature database. The powerline interference analyzer can also determine and provide (to a powerline network user or administrator) suggestions for mitigating or eliminating the effects of the identified noise sources. The detection of the noise sources can improve the PLC performance, minimize the probability of interference from the noise sources, increase the probability of a successful transmission, and reduce performance degradation.

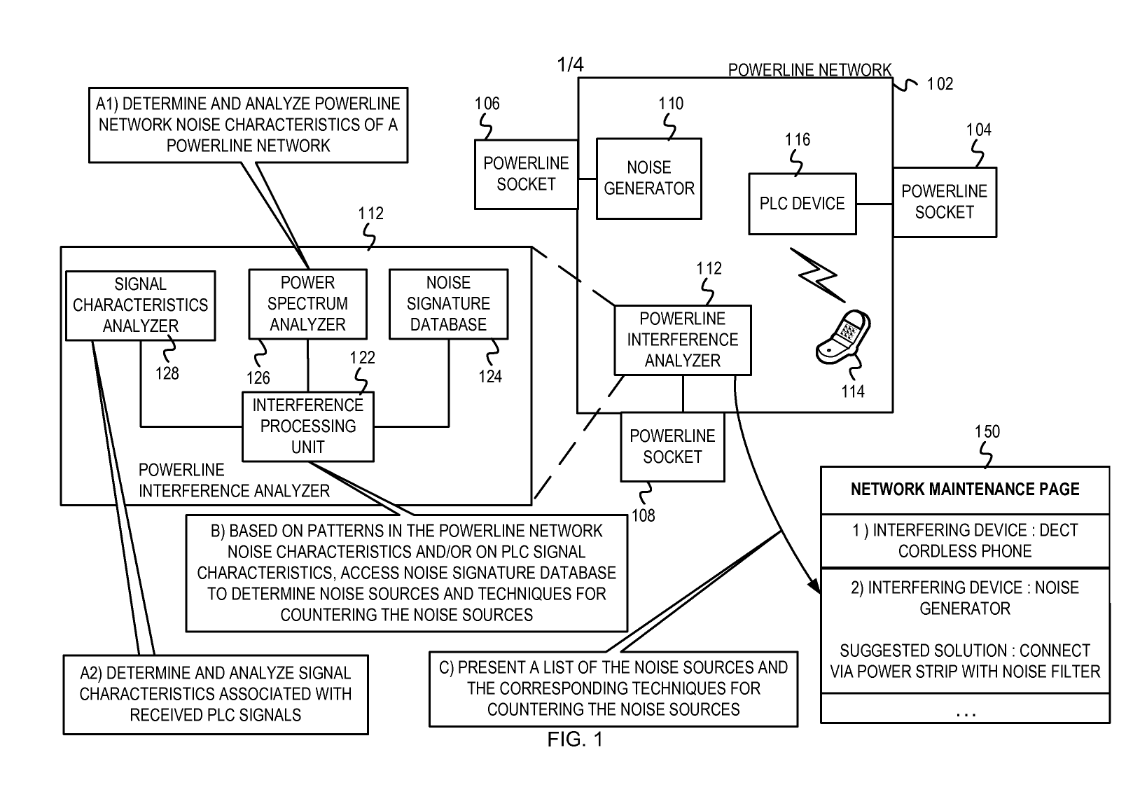

FIG. 1 is an example block diagram illustrating a powerline network 102 including a mechanism for identifying noise sources in the powerline network 102. The powerline network 102 of FIG. 1 comprises powerline sockets 104, 106, and 108 that enable powerline devices to connect to the powerline network 102. One or more electronic devices that introduce noise to the powerline network 102 may connect to the powerline network 102 via the powerline sockets. For example, as depicted in FIG. 1, a noise generator 110 (e.g., a hairdryer, an electric fan, etc.) is connected to the powerline network 102 via the powerline socket 106. Although not shown, in some examples, other noise sources may also be connected to the powerline network, such as entertainment systems, light dimmers, uninterrupted power supplies, surge protectors, and other consumer electronic devices. Also, as shown in FIG. 1, a powerline communication (PLC) device 116 that uses the powerline network 102 for exchanging data, connecting to the Internet, etc. is connected to the powerline network 102 via the powerline socket 104. A powerline interference analyzer 112 connects to the powerline network 102 via the powerline socket 108. The powerline interference analyzer 112 comprises a power spectrum analyzer 126, an interference processing unit 122, a noise signature database 124, and a signal characteristics analyzer 128. The interference processing unit 122 is coupled with the power spectrum analyzer 126, the noise signature database 124, and the signal characteristics analyzer 128. In some implementations (as depicted in FIG. 1), the powerline interference analyzer 112 may be a standalone powerline device configured to analyze the noise characteristics of the powerline network 102 and to determine causes of noise on the powerline network 102. However, in other implementations, powerline interference analyzer 112 may be implemented as part of one or more PLC devices (e.g., the PLC device 116). Additionally, in the example shown in FIG. 1, a wireless communication device 114 (e.g., a cordless phone, a baby monitor, etc.) communicates on an Industrial, Scientific, and Medical (ISM) radio frequency band in the vicinity of the powerline network 102.

It is noted that although FIG. 1 depicts the powerline network 102 comprising one PLC device 116, the powerline network 102 can comprise any suitable number of PLC devices that communicate with each other by exchanging PLC signals via the powerline medium (e.g., via power lines) that comprises the powerline network 102. Various factors can corrupt the PLC signals transmitted by the PLC devices (e.g., the PLC device 116). For example, the PLC signals and the powerline medium can be corrupted by noise generated by other powerline devices (e.g., the noise generator 110, dimmers, other household appliances, etc.) connected to the powerline network 102. As another example, the PLC signals can be attenuated or distorted by certain types of powerline devices such as power strips, surge protectors, uninterrupted power supply (UPS) devices, etc. Additionally, in some examples, the PLC signals generated by one class of PLC devices (e.g., HomePlug® devices) can be corrupted because of interference from non-compatible classes of PLC devices (e.g., G.HN devices, Opera® PLC devices, Panasonic® Wavelet PLC devices, and other PLC devices that employ proprietary PLC technologies). In yet another example, the PLC signals may be corrupted by radio signals (e.g., from a baby monitor) that get coupled to the powerline medium when the powerline medium acts as an antenna. As will be described below, the powerline interference analyzer 112 can analyze noise characteristics of the powerline network 102 (described in stage A1) and/or signal characteristics of received PLC signals (described in stage A2) to identify powerline devices (i.e., the noise sources) that could degrade PLC performance in the powerline network 102.

At stage Al, the power spectrum analyzer 126 determines and analyzes noise characteristics of the powerline network 102 (“powerline network noise characteristics”). The powerline network noise characteristics can be a time variation of the noise encountered on the powerline network 102 or frequency characteristics of the noise encountered on the powerline network 102 (“noise power spectrum”). In one implementation, the power spectrum analyzer 126 can collect measurements (e.g., during idle time periods, during previously allocated time intervals, etc.) for determining the powerline network noise characteristics. For example, the power spectrum analyzer 126 can collect measurements of reflected/radiated power in the powerline network 102 to determine and facilitate analysis of the powerline network noise characteristics.

The powerline network noise characteristics typically comprise a combination (or a superposition) of noise characteristics of various powerline devices connected to the powerline network 102. For example, when the powerline network noise characteristics are represented in terms of the noise power spectrum, the measured noise power spectrum (determined at stage A1) can comprise a combination of a power spectrum of the noise generator 110, a power spectrum of the wireless communication device 114, and power spectra of other powerline devices connected to the powerline network 102. Based on analyzing the powerline network noise characteristics (in the frequency domain and/or in the time domain), the power spectrum analyzer 126 can identify variations in the time/frequency domain characteristics (“noise patterns”) that can be uniquely associated with one or more noise sources that can corrupt PLC signals exchanged by the PLC devices 116 of the powerline network 102. For example, the power spectrum analyzer 126 may identify a constant interference noise pattern from the frequency-domain representation of the powerline network noise characteristics. As another example, the power spectrum analyzer 126 may identify a periodically repetitive impulse noise pattern from the time-domain representation of the powerline network noise characteristics.

At stage A2, the powerline interference analyzer 112 receives PLC signals from one or more PLC devices in the powerline network 102 and the signal characteristics analyzer 128 determines and analyzes signal characteristics associated with the received PLC signals. The signal characteristics can include signal to noise ratio (SNR), data rate, received signal strength, automatic gain control (AGC) setting, a bit error rate (BER), and other characteristics associated with the received PLC signals. The signal characteristics are representative of the attenuation/distortion encountered by the PLC signal on the powerline medium. For example, variation in SNR of the received PLC signal can be used as an indication of variation in attenuation experienced by the received PLC signal. In other words, a drop in the SNR of the received PLC signal for Xms can indicate the presence of an attenuating noise source during the Xms. Based on the variation of signal characteristics with respect to time and/or frequency, the signal characteristics analyzer 128 can determine noise characteristics (i.e., attenuation characteristics, distortion characteristics, etc.) and consequently one or more noise patterns. For example, the signal characteristics analyzer 128 can identify a potential noise pattern based on determining that a 20 dB drop in SNR is detected every 5 ms.

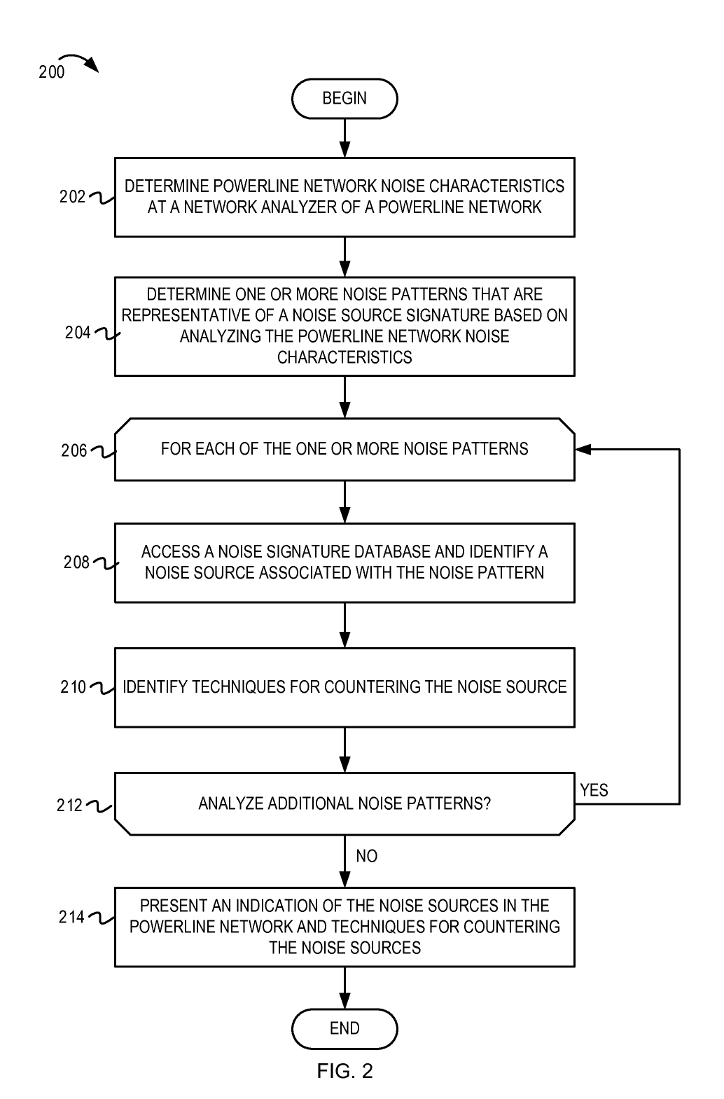

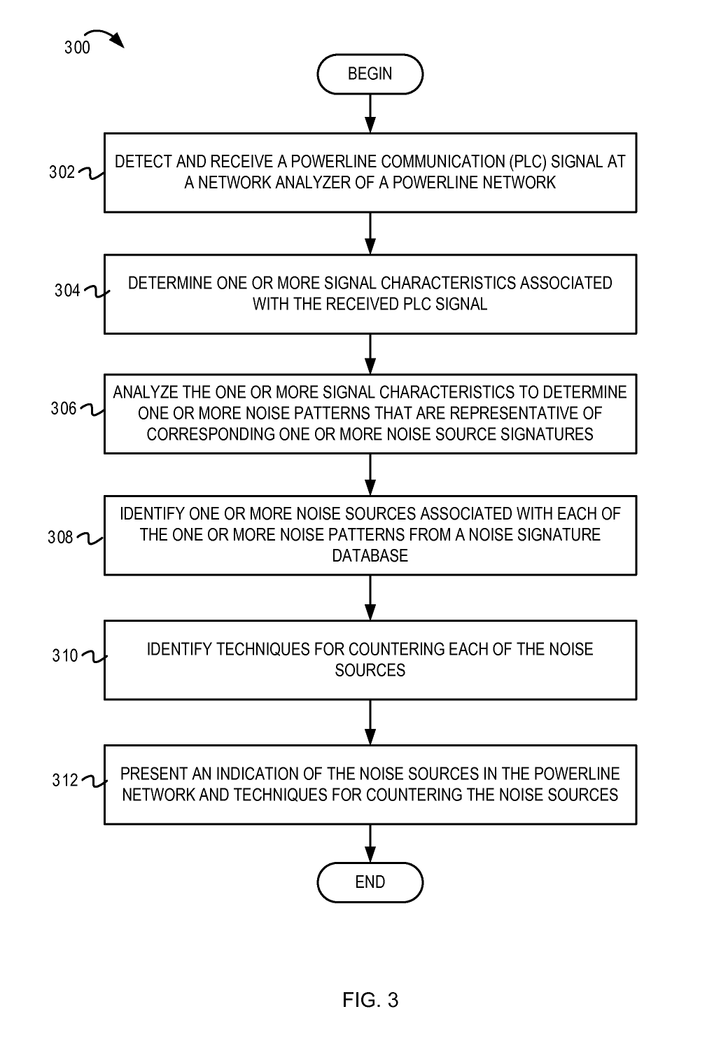

At stage B, based on the noise patterns in the powerline network noise characteristics and/or the signal characteristics associated with received PLC signals, the interference processing unit 122 accesses the noise signature database 124 and identifies noise sources and techniques for countering the noise sources. The noise signature database 124 can include predefined representations (in the time domain and/or the frequency domain) that uniquely represent each powerline or non-powerline device that can potentially be a noise source (e.g., to the PLC device 116) when connected to the powerline network 102. These unique, predefined representations of the powerline and non-powerline devices are herein referred to as “noise signatures”. The noise signature database 124 can include noise signatures for groups or classes of powerline/non-powerline devices (“classes of interfering devices”) with common (or similar) noise signatures. In other words, the noise signature database 124 can comprise a record of frequency spectra of various devices connected to, or in the vicinity of, the powerline network 102, so as to enable identification of the noise sources based on their frequency spectrum. The noise signature database 124 can also comprise a record of time domain characteristics of various powerline and non-powerline devices (that could potentially interfere with PLC signals exchanged by the PLC devices) to enable identification of the noise sources based on their time domain characteristics. As will be further described below with reference to FIGS. 2-3, the interference processing unit 122 compares the noise patterns (determined at stages A1 and A2) with the stored noise signatures to identify the noise sources. For example, the interference processing unit 122 can compare a constant interference noise pattern detected at stage Al with one or more noise signatures in the noise signature database 124 to determine that the noise source is the noise generator 110. As another example, the interference processing unit 122 can compare a variation in SNR determined based on analyzing the signal characteristics at stage A2 with one or more noise signatures in the noise signature database 124 to determine that the noise source is a light dimmer. Additionally, the noise signature database 124 can also indicate techniques for minimizing the effect of the noise sources. With reference to the above example, where the interference processing unit 122 determines that the noise generator 110 is the noise source, the interference processing unit 122 can also determine (from the noise signature database 124) that the effect of the noise generator 110 can be minimized by connecting the noise generator 110 to the powerline network 102 via a power strip with a noise filter. In some implementations, based on the noise patterns detected at stages A1 and/or A2, the interference processing unit 122 may determine that the noise source is the wireless communication device 114 (e.g., a cordless phone, a baby monitor, or other devices that use the ISM frequency band for transmitting data). The interference processing unit 122 may determine that the interference from the wireless communication device 114 can be minimized by switching off the wireless communication device 114 or by moving the wireless communication device 114 away from the PLC device 116. In some implementations, based on the noise patterns detected at stages A1 and/or A2, the interference processing unit 122 may determine that the noise source is a non-compatible PLC device. The interference processing unit 122 may determine that the interference from the non-compatible PLC device can be minimized by preventing communications of the PLC device 116 during intervals when communications of the non-compatible PLC device are detected.

At stage C, the powerline interference analyzer 112 presents (on a network maintenance page 150) a list of the noise sources and the corresponding techniques for countering the noise sources. The interference processing unit 122 can use the network maintenance page 150 to notify a user (e.g., a powerline network administrator) of possible sources of noise/interference on the powerline network 102, or in the vicinity of the powerline network 102. As described above, in one example, the interference processing unit 122 can indicate on the network maintenance page 150 that the wireless communication device 114 (i.e., a baby monitor) in the ISM frequency band and the noise generator 110 are possible sources of interference. As depicted in FIG. 1, the interference processing unit 122 may also provide solutions (if available) for reducing the interference. In FIG. 1, the interference processing unit 122 indicates that interference caused by the noise generator 110 can be reduced by connecting the noise generator 110 to the powerline network 102 via a power strip with a noise filter. In some implementations, the network maintenance page 150 may be presented on a display unit that is a part of the powerline interference analyzer 112. In another implementation, the network maintenance page 150 may be displayed on a website. A user may log in to the website and access a list of devices connected to the powerline network 102, a list of powerline devices and wireless communication devices that cause interference on the powerline network 102, and solutions for reducing the interference on the powerline network 102. In yet another implementation, the network maintenance page 150 may be presented on a computer system (e.g., a display unit of the computer system) that is externally coupled with the powerline interference analyzer 112.

It is noted that the operations of stage A1 and stage A2 may be executed independently of each other or in combination. For example, the powerline interference analyzer 112 may first analyze the noise characteristics based on measurements collected during idle time periods to identify one or more noise sources on the powerline network 102 (as described in stage A1). On receiving PLC signals, the powerline interference analyzer 112 can analyze signal characteristics associated with the received PLC signals (as described in stage A2) to verify the previously identified noise sources and/or to identify other previously undetected noise sources on the powerline network 102.

FIG. 2 is a flow diagram (“flow”) 200 illustrating example operations for determining noise sources in a powerline network based on analyzing powerline network noise characteristics. The flow 200 begins at block 202.

At block 202, the powerline network noise characteristics are determined at a network analyzer of a powerline network. For example, with reference to FIG. 1, the power spectrum analyzer 126 of the powerline interference analyzer 112 can determine the powerline network noise characteristics of the powerline network 102. The powerline network noise characteristics can be a time variation of the noise encountered on the powerline network 102 or a frequency variation of the noise encountered on the powerline network 102 (noise power spectrum”). In one implementation, when the powerline network noise characteristics are represented in terms of the noise power spectrum, to analyze the noise power spectrum associated with the powerline network 102 (as will be described below in FIG. 2) the powerline interference analyzer 112 may necessitate the powerline network 102 to be free from extraneous PLC communications. In one implementation, the operations for determining the powerline network noise characteristics can be executed during idle time slots. For example, the powerline interference analyzer 112 may determine when the PLC medium is free (i.e., when none of the PLC devices in the powerline network 102 are transmitting) and can collect measurements for determining the powerline network noise characteristics. As another example, the powerline interference analyzer 112 can collect measurements for determining the powerline network noise characteristics during inter-frame gaps between successive transmissions. In another implementation, the operations for determining the powerline network noise characteristics can be executed periodically and/or in designated time intervals. In another implementation, the powerline interference analyzer 112 may force a quiet period (e.g., on detecting PLC performance degradation) and can collect measurements for determining the powerline network noise characteristics during the forced quiet period.

In some implementations, when the PLC devices in the powerline network 102 support time division multiple access (TDMA), the powerline interference analyzer 112 can collect measurements for determining the powerline network noise characteristics during TDMA allocation periods when the PLC devices are prevented from transmitting. For example, when the powerline network 102 comprises HomePlug AV PLC devices, a central network coordinator may allocate one or more TDMA time slots for measurement and analysis of the powerline network noise characteristics. In some implementations, as part of collecting measurements for determining the powerline network noise characteristics, the powerline interference analyzer 112 can measure the level and type of noise at the powerline socket 108 to which the powerline interference analyzer 112 is connected. As will be described below, the type of noise can include information such as whether the noise is impulsive noise, whether the noise is AC line cycle dependent noise, etc. The level of noise may indicate a magnitude of the noise (e.g., measured in dB). Measurements of reflected/radiated power in the powerline network 102 may also be collected as part of determining the powerline network noise characteristics. The flow continues at block 204.

At block 204, one or more noise patterns that are representative of a noise source signature are determined based on analyzing the powerline network noise characteristics. For example, the power spectrum analyzer 126 can determine the one or more noise patterns based on analyzing the powerline network noise characteristics. Noise generated by various devices in the powerline network 102 (i.e., a noise signature of the devices) can have specific time-domain characteristics and frequency-domain characteristics that can enable identification of the powerline and non-powerline devices that generated the noise (i.e., the noise sources). For example, light dimmers typically generate impulsive noise at various portions of the AC line cycle when the light dimmers switch on/off. Thus, the power spectrum analyzer 126 can analyze a time variation of the powerline network noise characteristics to detect time-varying noise patterns or AC line cycle dependent noise patterns. As another example, hair dryers (and other such devices) can produce noise throughout the AC line cycle. Thus, the power spectrum analyzer 126 can analyze a frequency variation of the powerline network noise characteristics (e.g., can analyze a noise power spectrum) to detect time-invariant and frequency-invariant noise patterns. The flow continues at block 206.

At block 206, a loop begins for analyzing each of the one or more noise patterns. For example, the interference processing unit 122 can initiate a loop to analyze each of the one or more noise patterns determined at block 204. As will be further described below, the one or more noise patterns determined from the powerline network noise characteristics can be used (in either the time domain or the frequency domain) in conjunction with the noise signature database 124 to identify a noise source that corresponds to the noise patterns. The flow continues at block 208.

At block 208, the noise signature database is accessed and the noise source associated with the noise pattern is identified. The noise signature database 124 can comprise a list of noise signatures of individual devices or a class of interfering devices that can potentially corrupt PLC signals exchanged on the PLC medium. The noise signatures of the devices can be represented as a power spectrum (e.g., a frequency domain representation) of the noise generated by a particular device. Additionally, the noise signatures of the devices can also comprise information regarding the variation of the noise (generated by the device) with respect to the AC line cycle. The frequency domain characteristics of the noise generated by a noise source can be mapped to corresponding time domain characteristics. Therefore, in some implementations, the noise signature database 124 can comprise either the time-domain representation of the noise generated by the noise sources or the frequency-domain representation of the noise generated by the noise sources. To identify a particular noise source, the interference processing unit 122 can convert between the time-domain representation of the noise pattern and the frequency-domain representation of the noise pattern as needed. The interference processing unit 122 can compare the noise pattern against the appropriate representation of the noise signature in the noise signature database 124. In another implementation, however, the noise signature database 124 can comprise both the time-domain representation and the frequency-domain representation of the noise generated by the noise sources. In yet another implementation, any suitable representation of the noise generated by the noise sources can be stored in the noise signature database 124. For example, the time-domain characteristics of the noise generated by the light dimmers can be stored in the noise signature database 124, while the frequency-domain characteristics of the noise generated by the hair dryer may be stored in the noise signature database 124. In some implementations, the noise signature database 124 can comprise noise signature for classes of devices. For example, hairdryers, electric fans, microwave ovens, and other such household appliances comprise electric motors that generate noise with similar noise characteristics (e.g., time domain characteristics or frequency domain characteristics). Therefore, the hairdryers, electric fans, microwave ovens, and other such household appliances may be classified under a common class of interfering powerline devices and a single noise signature associated with the common class of interfering powerline devices may be stored in the noise signature database 124.

In conjunction with the power spectrum analyzer 126, the interference processing unit 122 can access the noise signature database 124 and can determine the noise source associated with the noise pattern. For example, the power spectrum analyzer 126 may determine a constant interference noise pattern. The interfering device analyzer 122 may access the noise signature database 124 and may determine that common household appliances (e.g., hairdryers, electric fans, etc.) typically produce noise that is constant with time. In other words, the interfering device analyzer 122 may identify noise sources associated with a constant interference noise signature. As another example, the power spectrum analyzer 126 may determine that a time-variant noise pattern. The interfering device analyzer 122 may also determine the periodicity associated with the time-varying noise pattern. In some implementations, based on the intensity setting to which a noise source (e.g., a light dimmer) is adjusted, the light dimmer switches on/off for predetermined time intervals of an AC line cycle. If the intensity setting is at the maximum value, the light dimmer may not switch off during the AC line cycle. However, if the intensity setting is at another smaller value, the light dimmer may switch on (and produce noise on the powerline network 102) for only a portion of the AC line cycle. Thus, the interfering device analyzer 122 may access the noise signature database and may determine (based on knowledge that the noise pattern represents an AC line cycle synchronized noise and based on the periodicity associated with the noise pattern) that light dimmers typically produce time-varying noise.

In some implementations, the interference processing unit 122 may be unable to determine the exact noise source that generated the noise pattern because different noise sources can produce a similar noise pattern. For example, the interference processing unit 122 may be unable to determine, from the noise pattern and the noise signature database 124, whether a hairdryer, an electric fan, or another consumer electronic device generated the noise pattern. However, based on the noise pattern and the noise signature database 124, the interference processing unit 122 may identify a class of interfering devices to which the noise source belongs. For example, the interference processing unit 122 may determine that the constant interference noise pattern was generated by a powerline device that belongs to a class of household appliances. As another example, the interference processing unit 122 may determine that the time-varying noise pattern was generated by a noise source that belongs to a class of impulse noise generating devices. The flow continues at block 210.

At block 210, techniques for countering the noise source are identified. For example, the interference processing unit 122 can determine the techniques for countering the noise source (determined at block 208) from the noise signature database 124. In some implementations, different noise sources can be associated with different noise mitigation techniques. For example, on detecting that the noise source is an entertainment system, the interference processing unit 122 can determine (from the noise signature database 124) that the entertainment system should be connected to the powerline network 102 via a noise filter. As another example, the interference processing unit 122 can determine that the effect of the noise source can be mitigated by unplugging the noise source from the powerline network 102 (e.g., unplugging an electric fan). As another example, the interference processing unit 122 can determine that the effect of the noise source can be reduced by connecting the noise source to a different powerline outlet. For example, if the user does not wish to disconnect the noise source (e.g., the electric fan) from the powerline network 102, the interference processing unit 122 can suggest that the electric fan be connected to another powerline outlet that is sufficiently far away from the PLC device 116 with which the electric fan is interfering. The flow continues at block 212.

At block 212, it is determined whether additional noise patterns are to be analyzed. For example, the interference processing unit 122 can determine whether additional noise patterns are to be analyzed to determine corresponding noise sources. If it is determined that additional noise patterns are to be analyzed, the flow loops back to block 206 where a next noise pattern is identified and analyzed to determine a corresponding next noise source. Otherwise, the flow continues at block 214.

At block 214, an indication of the noise sources in the powerline network and techniques for countering the noise sources are presented. For example, the powerline interference analyzer 112 can present on the network maintenance page 150 the indication of the noise sources in the powerline network 102 (determined at block 208). The powerline interference analyzer 112 can also present on the network maintenance page 150 corresponding techniques for minimizing the effect of the noise generated by the identified noise sources (determined in block 210). For example, as described above, the network maintenance page 150 can indicate that the electric fan is generating noise in the powerline network 102 and can suggest that the electric fan be disconnected from the powerline network 102. In some implementations, the interference processing unit 122 may determine and indicate a class of interfering devices to which the noise source belongs. In addition to determining and indicating the class of interfering devices to which the noise source belongs, the interference processing unit 122 may also indicate example devices that fall within the identified class of interfering devices. For example, the network maintenance page 150 may indicate that a class of constant-noise generating devices is producing noise that could impact the PLC performance. The interference processing unit 122 may indicate that hair dryers, electric fans, and other such consumer electronic devices typically fall within the class of constant-noise generating devices. Furthermore, in some examples, the interference processing unit 122 may be unable to identify the noise source, the class of interfering devices to which the noise source could belong, and/or techniques for minimizing the effect of the noise source. In these examples, the interference processing unit 122 can indicate, via the network maintenance page 150, that the powerline outlet to which the PLC device 116 is connected is noisy, resulting in potential PLC performance degradation. Also, in these examples, the interference processing unit 122 may suggest, via the network maintenance page 150, that the user should connect the PLC device 116 to the powerline network 102 via a filter and/or should disconnect all other devices connected to the powerline network 102.

In some implementations, the network maintenance page 150 may also be used to indicate information about the level (e.g., amplitude) and type (e.g., constant noise, time-variant noise) of noise at a particular powerline socket. In some implementations, the network maintenance page 150 may provide additional suggestions for connecting PLC devices (e.g., the PLC device 116) to the powerline socket based on the level and the type of noise. For example, if the noise level at a powerline socket is high, the user may be advised (via the network maintenance page 150) to connect the PLC device 116 to another (less noisy) powerline socket. As another example, if the noise level at a powerline socket is high, the user may be advised to connect the noise sources to the powerline network 102 using a low pass filter to reduce the noise introduced by noise sources at the PLC device 116. From block 214, the flow ends.

Although FIG. 2 describes the powerline interference analyzer 112 determining noise sources in the powerline network 102 based on analyzing powerline network noise characteristics in the absence of PLC signals, embodiments are not so limited. In other implementations, the powerline interference analyzer 112 can determine signal characteristics associated with one or more received PLC signals. The powerline interference analyzer 112 can analyze a variation of the signal characteristics to predict the noise sources on the powerline network 102, as will be described with reference to FIG. 3.

FIG. 3 is a flow diagram 300 illustrating example operations for determining noise sources in a powerline network based on analyzing signal characteristics of powerline communication (PLC) signals. The flow 300 begins at block 302.

At block 302, a PLC signal is detected at a network analyzer of a powerline network. For example, with reference to FIG. 1, the powerline interference analyzer 112 can detect and receive the PLC signal. The powerline interference analyzer 112 can analyze the PLC signal received at the PLC device 116 to identify the noise sources on the powerline network 102. In one implementation, the operations for determining the noise sources (as described with reference to FIG. 3) can be executed when PLC signals comprising special PLC packets are detected. For example, PLC signals comprising a Sound MPDU packet from a HomePlug AV device can be analyzed. In another implementation, PLC signals comprising any suitable PLC packets can be analyzed. In one implementation, the powerline interference analyzer 112 may analyze PLC signals received only from specific PLC devices (e.g., predetermined PLC devices). In another implementation, the powerline interference analyzer 112 may analyze PLC signals received from all PLC devices connected to the powerline network 102. As will be described below, the powerline interference analyzer 112 can measure and analyze signal characteristics associated with PLC signals received from one or more PLC devices to identify noise sources in the powerline network 102. The flow continues at block 304.

At block 304, one or more signal characteristics associated with the received PLC signal are determined. For example, the signal characteristics analyzer 128 can determine one or more signal characteristics associated with the received PLC signal. As part of determining the signal characteristics associated with the received PLC signal, the signal characteristics analyzer 128 can determine a signal to noise ratio (SNR), signal level (e.g., amplitude), AGC level, data rate, a bit error rate (BER), and/or other performance indicators associated with the received PLC signal. The signal characteristics can serve as indicators of powerline network noise characteristics including signal attenuation characteristics and signal distortion characteristics associated with the powerline network 102. In one implementation, the signal characteristics analyzer 128 can calculate the signal characteristics in successive intervals of time to determine the variation of the signal characteristic with time. For example, the signal characteristics analyzer 128 can divide a 60 Hz (or 16.6 ms) AC line cycle into ten (or another suitable number of) sub-intervals and can calculate the SNR of the received PLC signal in each of the ten sub-intervals. In some implementations, the signal characteristics analyzer 128 can determine the signal characteristics associated with one packet (or one PLC signal). In other implementations, the signal characteristics analyzer 128 can determine the signal characteristics associated with multiple PLC signals and can combine the signal characteristics associated with each of the PLC signals to yield a cumulative representation of the signal characteristics. As will be described below, the PLC device analyzer 112 can use the signal characteristics associated with the PLC signals received from one or more PLC devices in conjunction with the noise signature database 124 to identify the noise sources. The flow continues at block 306.

At block 306, the one or more signal characteristics are analyzed to determine one or more noise patterns that are representative of corresponding one or more noise source signatures. For example, the signal characteristics analyzer 128 can analyze the one or more signal characteristics to determine the noise patterns. The noise sources can affect (or distort) PLC signals during a specific time duration, a portion of the frequency spectrum, a portion of the AC line cycle, etc. As described above, the noise (including attenuation, distortion, interference, etc.) generated by various devices in the powerline network 102 (i.e., a noise signature of the devices) can have specific time-domain characteristics and frequency-domain characteristics that can be used to identify the powerline or non-powerline device that generated the noise (i.e., the noise source). For example, variation of SNR associated with the received PLC signal with time can be analyzed to predict the noise source. The signal characteristics analyzer 128 may detect (based on analyzing the SNR across consecutive time intervals) a constant SNR for most of the AC line cycle and may detect a drop in SNR at periodic intervals. In some implementations, the signal characteristics analyzer 128 can compare the SNR associated with the received PLC signal against a threshold SNR to determine whether the SNR has dropped because of the effect of a noise source in the powerline network 102. A periodic drop in the SNR can indicate that the noise source generates noise at periodic intervals of time. As another example, variation of data rate with time can be analyzed to predict the noise source. The signal characteristics analyzer 128 may detect (based on analyzing the data rate across consecutive time intervals) a constant data rate for most of the AC line cycle and may detect a drop in the data rate at periodic intervals. This can indicate that the noise source generates a periodic noise pattern. As another example, the signal characteristics analyzer 128 can compare the signal level associated with the received PLC signal against a threshold signal level to determine whether the signal level associated with the received PLC signal has dropped because of the effect of a noise source in the powerline network 102.

In some implementations, the signal characteristics analyzer 128 can use the SNR of the received PLC signal in conjunction with an AGC setting (applied to the received PLC signal by the powerline interference analyzer 112) to determine the noise pattern including the signal distortion or attenuation characteristics. In some implementations, an AGC unit (not shown) associated with the powerline interference analyzer 112 can be used to amplify the received PLC signal to ensure that the PLC signal is sufficiently amplified before being provided to subsequent processing components and to ensure optimal performance of the subsequent processing components. In other words, the AGC setting can indicate a factor by which the received PLC signal was amplified prior to being provided to the subsequent processing units. Therefore, the AGC setting can serve as an indication of the signal level of the received PLC signal. In some implementations, variations in the AGC setting over time (or over an AC line cycle) can be used to identify variations in the signal level associated with the received PLC signal and consequently to determine the noise patterns in the received PLC signal. Furthermore, the signal characteristics analyzer 128 could analyze the AGC settings, the SNR, the absolute signal strength, received signal strength indicator (RSSI), BER, etc. separately or in combination to determine the noise patterns in the received PLC signal.

Furthermore, in some implementations, the PLC signal may be attenuated/distorted by noise sources even if the PLC signal does not pass through the noise source. For example, cell phone chargers can vary the input impedance, can provide different input impedance at different portions of the AC line cycle, and can cause a PLC signal to not get properly injected into the powerline medium. This can results in variation in the signal attenuation characteristics, which can adversely affect the performance of the PLC device 116. In one implementation, the signal characteristics analyzer 128 can analyze the input impedance detected by various PLC devices in the powerline network to determine a noise pattern. For example, the signal characteristics analyzer 128 can receive an indication of the input impedance as calculated by multiple PLC devices connected to the powerline network 102. The signal characteristics analyzer 128 can estimate the noise pattern and can consequently identify the noise source that generated the noise pattern by analyzing a combination of the input impedance received from the multiple PLC devices. The flow continues at block 308.

At block 308, one or more noise sources associated with the one or more noise patters are identified from a noise signature database. As described above, the noise signature database 124 can comprise a list of noise signatures associated with individual noise sources or with classes of interfering devices. In some implementations, the noise signature database can comprise signal attenuation characteristics and/or distortion characteristics for various noise sources (and/or various classes of interfering devices). For example, the noise signature database 124 can comprise attenuation characteristics associated with a light dimmer, a surge protector, and various other devices that can attenuate PLC signals transmitted by PLC devices in the powerline network 102. As another example, the noise signature database 124 can indicate that the light dimmer can cause attenuation of the PLC signal by a factor of X db. As yet another example, the noise signature database 124 can indicate that an Uninterrupted Power Supply (UPS) device can cause attenuation of the PLC signal in 20% of a 60 Hz AC line cycle.

The interference processing unit 122 can access the noise signature database 124 and can determine the noise source associated with the noise patterns identified by the signal characteristics analyzer 128. For example, the signal characteristics analyzer 128 may determine that the noise is generated at periodic intervals of time (i.e., a periodic noise pattern). Based on accessing the noise signature database 124, the interference processing unit 122 can determine that a noise signature associated with a light dimmer indicates that a light dimmer generates noise at periodic intervals of the AC line cycle. Accordingly, the interference processing unit 122 can indicate that the noise source is probably a light dimmer. As another example, the interference processing unit 122 may compare the observed variation in the data rate associated with the received PLC signal with the expected variation of the data rate (for a particular noise source) to predict the noise source. As another example, the power spectrum analyzer 126 may determine that the PLC signal was attenuated by a factor of Xdb. Accordingly, based on a noise signature in the noise signature database 124 that is associated with Xdb attenuation, the interference processing unit 122 can determine that the powerline interference analyzer 112 is probably connected to the powerline network 102 via a UPS device which, in turn, resulted in PLC performance degradation. As another example, based on attenuation characteristics or distortion characteristics of the noise pattern, the interference processing unit 122 may determine that one or more power strips with inbuilt surge protection resulted in PLC performance degradation. As another example, based on variations in input impedance detected by the signal characteristics analyzer 128, the interference processing unit 122 can determine that the noise source is probably a cell phone charger.

In some implementations, the interference processing unit 122 can receive, from the signal characteristics analyzer 128, an indication of a variation of signal attenuation/distortion. The interference processing unit 122 can compare the variation of signal attenuation/distortion with predefined variations of signal attenuation/distortion from the noise signatures stored in the noise signature database 124 to identify the noise source. For example, the interference processing unit 122 can predict that the noise source is probably a cell phone charger, based on comparing the variation of the signal attenuation (e.g., variation in SNR associated with the received PLC signal) with respect to the AC line cycle with predefined variations of the signal attenuation with respect to the AC line cycle in the noise signature database 124 (e.g., predefined variations in SNR caused by various noise sources).

In some implementations, the interference processing unit 122 can compare signal characteristics against signal characteristic thresholds to determine the noise source. For example, the interference processing unit 122 may compare the signal level associated with one or more received PLC signals (or a combined signal level associated with a combination of received PLC signals) with one or more threshold signal levels. For example, the interference processing unit 122 may compare the signal levels associated with multiple received PLC signals received from corresponding multiple PLC devices in the powerline network 102 with the threshold signal level. The interference processing unit 122 may determine that signal levels associated with PLC signals from all the transmitting PLC devices have been attenuated and may calculate an attenuation factor. The interference processing unit 122 can also compare the attenuation factor against an expected (or typical) attenuation factor in an attempt to identify the noise source that is causing the attenuation. For example, the noise signature database 124 may indicate that the expected attenuation factor in a building environment is the range of 20 dB to 40 db and that surge protectors typically attenuate the received PLC signal by a factor of 20 dB. The calculated attenuation factor associated with the received PLC signals may be 60 dB. Accordingly, the interference processing unit 122 may determine that the powerline interference analyzer 112 is connected to the powerline network 102 via a surge protector. As another example, it may be determined that the signal strength associated with the received PLC signal is strong in one portion of the AC line cycle and is weak (e.g., below a threshold signal level) for the remainder of the AC line cycle. The noise signature database 124 could indicate typical time durations for which different noise sources switch on and consequently attenuate the received PLC signal. Based on comparing the duration of the AC line cycle for which the signal strength is weak with the typical time durations indicated in the noise signature database 124, the interference processing unit 122 may determine that the noise source is a cell phone charger. In some implementations, a combination of two or more signal characteristics could be used to identify the noise source. For example, the interference processing unit 122 may compare the physical layer data rates associated with the received PLC signal with threshold physical layer data rates and may compare the signal level associated with the received PLC signal with a threshold signal level. The physical layer data rate being less than the threshold physical layer data rates and the signal level associated with the received PLC signal being less than the threshold signal level can serve as an indication that received the PLC signal was attenuated by a power strip.

In some implementations, the interference processing unit 122 may be unable to determine the exact noise source that generated the noise pattern (and the attenuation/distortion characteristics) because different noise sources can produce a similar noise pattern. For example, the interference processing unit 122 may be unable to determine, from the noise pattern and the noise signature database 124, whether a hairdryer or an electric fan generated the noise pattern. However, the interference processing unit 122 may identify a class of interfering devices to which the noise source belongs. For example, the interference processing unit 122 may determine that the noise source belongs to a class of household appliances. As another example, the interference processing unit 122 may determine that the noise source belongs to a class of periodic noise generating devices. In some implementations, instead of identifying the noise source, the interference processing unit 122 can use physical layer data rates obtained from one or more other PLC devices in the powerline network 102 to determine the presence of noise sources that can result in PLC performance degradation. The flow continues at block 310.

At block 310, techniques for countering each of the noise sources are identified. For example, the interference processing unit 122 can determine the techniques for countering each of the noise sources (determined at block 308) from the noise signature database 124. As described above, with reference to FIG. 2, in addition to the noise characteristics associated with each of the noise sources (or a class of interfering devices), the noise signature database 124 could also comprise one or more techniques for eliminating or minimizing the noise generated by the noise source. For example, on determining that a UPS device or a surge protector is attenuating or distorting the received PLC signal, the interference processing unit 122 can determine that the attenuating effect of the UPS device can be mitigated by not connecting the PLC device 116 via the UPS device (i.e., by directly connecting the PLC device 116 to the powerline network 102). As another example, if the noise source is determined to be a cell phone charger, the interference processing unit 122 can determine that the distorting effect of the cell phone charger can be minimized by disconnecting the cell phone charger from the powerline network 102, by connecting the cell phone charger to a powerline socket that is farther away from the PLC device, or by connecting the cell phone charger to the powerline network 102 via a noise filter. The flow continues at block 312.

At block 312, an indication of the noise sources in the PLC network and techniques for countering the noise sources are presented. As described above, the powerline interference analyzer 112 can use the network maintenance page 150 to identify the noise sources in the powerline network 102 and to suggest techniques for minimizing the effect of the noise sources. For example, the powerline interference analyzer 112 can indicate (via the network maintenance page 150) that degradation in PLC performance may be attributed to the presence of surge protectors and UPS devices in the powerline network 102. The powerline interference analyzer 112 can indicate that the PLC performance may be improved by removing the UPS devices (and the surge protectors) from the powerline network 102 or by connecting the UPS devices (and the surge protectors) to the powerline network 102 via a noise filter. From block 312, the flow ends.

It should be understood that FIGS. 1-3 are examples meant to aid in understanding embodiments and should not be used to limit embodiments or limit scope of the claims. Embodiments may perform additional operations, fewer operations, operations in a different order, operations in parallel, and some operations differently. In some embodiments, the operations described in FIG. 2 and FIG. 3 can be executed independently or in combination. For example, the powerline interference analyzer 112 can, during an idle time period, determine and analyze a noise frequency spectrum to identify noise sources in the powerline network 102. Next, on receiving PLC signals from one or more PLC devices in the powerline network 102, the powerline interference analyzer 112 can determine signal characteristics (e.g., SNR) associated with the received PLC signals to identify other noise sources that attenuate/distort the received PLC signals. Furthermore, in some implementations, both the noise frequency spectrum and the signal characteristics can be analyzed to identify a single noise source or a class of interfering devices that is degrading the PLC performance. For example, based on detecting impulse noise patterns in the noise frequency spectrum and based on detecting periodic SNR degradation in the analysis of the signal characteristics, the powerline interference analyzer 112 may determine that the noise source is a light dimmer.

In some implementations, the noise sources in the powerline network 102 may generate noise/interference/distortion only when they are switched on (e.g., by the user, automatically as part of a periodic switch on/switch off cycle, etc.). The powerline interference analyzer 112 can analyze the noise characteristics including noise frequency spectrum, variation of signal characteristics, etc. and can identify time intervals when the noise was generated. For example, the powerline interference analyzer 112 may detect a spike in the noise frequency spectrum (or a drop in the SNR of a received PLC signal) every 1 ms. The powerline interference analyzer 112 can present, on the network maintenance page 150, information about the time intervals during which various types of noise patterns were detected. For example, the powerline interference analyzer 112 may indicate that from 5:00 pm to 5:30 pm, a constant interference noise pattern was detected. The network maintenance page 150 may also indicate that the constant interference noise pattern was probably generated because a household appliance was connected to the powerline network 102 and switched on. The powerline interference analyzer 112 may indicate (via the network maintenance page 150) that a noise spike was detected in the powerline network 102 at 5:15 pm, possibly due to a noise source being switched on or switched off. In some implementations, if the interference processing unit 122 is unable to identify the noise source, the class of interfering devices to which the noise source belongs, and/or techniques for minimizing the effect of the noise source, the interference processing unit 122 can provide information (via the network maintenance page 150) about a time instant (or a time period) when the noise pattern was detected, a powerline socket at which a potential noise source was detected, etc. The user can utilize this information to identify devices that could potentially be noise sources based on the user's knowledge of which devices are connected to the powerline network 102, when the devices were connected to the powerline network 102, when the devices were switched on/off, etc. With reference to the above example, based on knowledge that the electric fan was in use between 5:00 pm and 5:30 pm and based on the information provided via the network maintenance page 150 (by the powerline interference analyzer 112), the user may infer that the PLC performance degradation was caused by the electric fan. In some implementations, the powerline interference analyzer 112 may also provide, via the network maintenance page 150, information regarding the variation in signal characteristics (e.g., SNR, data rate, signal level, etc.). For example, the powerline interference analyzer 112 may identify a time instant at which the data rate dropped below a threshold data rate, a time interval for which the data rate stayed below the threshold data rate, etc. As described above, the user can utilize this information to identify noise sources that could potentially be attenuating, distorting, or interfering with proper communication of the PLC signals.

Furthermore, the powerline interference analyzer 112 may also detect non-compatible PLC devices in the powerline network 102. For example, if the powerline network 102 comprises HomePlug devices, one or more G.HN devices in the powerline network 102 may be considered to be non-compatible PLC devices to the HomePlug devices. The powerline interference analyzer 112 can employ any suitable techniques to detect the presence of the non-compatible PLC devices. In one implementation, the noise frequency spectrum (or received PLC signals) can be analyzed to detect an interference pattern associated with the non-compatible PLC devices. For example, the non-compatible PLC devices can cause interference when they transmit a packet via the PLC medium. During the packet transmission, the packet transmitted by the non-compatible PLC devices can interfere with other PLC signals transmitted in the same frequency band. Also, the interference cause by packet transmissions of the non-compatible PLC devices can disappear after packet transmission is completed. In some implementations, the powerline interference analyzer 112 may determine that packet transmission durations associated with (and consequently time durations for which interference is generated by) the non-compatible PLC devices are unpredictable and not constant (unlike noise produced by other noise sources such as household appliances). Therefore, the presence of unpredictable, unique interference patterns can be used to infer the presence of non-compatible PLC systems. In another implementation, the non-compatible PLC devices may periodically transmit packets for network maintenance. The presence of such periodic interference can be used to identify the presence of non-compatible PLC devices. For example, the powerline interference analyzer 112 may detect a transmission (or the same interference pattern) every 33 ms. Based on the noise signature database 124 and the calculated periodicity of the interference pattern, the powerline interference analyzer 112 may identify the class of non-compatible PLC devices in the powerline network 102. The powerline interference analyzer 112 may also analyze time-domain noise pattern variations or the noise frequency spectrum to determine whether the interference was generated by a noise source or by a non-compatible PLC device. In another implementation, the powerline interference analyzer 112 may be capable of detecting unique patterns (e.g., in a preamble) transmitted by the non-compatible PLC devices. The powerline interference analyzer 112 can determine the presence of (and can even identify) the non-compatible PLC devices in the powerline network 102 based on detecting data in the preamble that is indicative of a non-compatible PLC device (and/or other preamble patterns). On detecting the non-compatible PLC devices in the powerline network 102, the powerline interference analyzer 112 could indicate the presence of the non-compatible PLC devices on the network maintenance page 150. The powerline interference analyzer 112 may also identify (if possible) PLC standards being implemented by the non-compatible PLC devices (e.g., whether the non-compatible PLC device is a G.HN device). In some implementations, the powerline interference analyzer 112 may also comprise functionality for determining and indicating time intervals during which the non-compatible PLC device is expected to initiate communications, thus attempting to minimize interference between communications of the different classes of PLC devices.

Furthermore, it is also noted that in some implementations, the powerline interference analyzer 112 may also detect the presence of wireless radio signals that leak into and that get coupled to the powerline medium (also known as “ingress signals”). For example, the wireless radio signals that occupy the same frequency bands as the PLC devices can interfere with communications of the PLC devices. The powerline interference analyzer 112 can detect the presence of the ingress signals by analyzing the noise frequency spectrum and detecting a large number of signals (or a large signal level) at specific frequencies of the noise frequency spectrum. The ingress signals may also have frequency characteristics that are similar to the frequency characteristics of frequency jamming devices. The powerline interference analyzer 112 can use various jamming detection techniques to detect the presence of the ingress signals and can provide suggestions for minimizing the effect of the ingress signals (e.g., switching off a cordless phone or another RF communication system).

Lastly, in some implementations, the detection of the noise sources in the powerline network 102 may also be used for making route-selection decisions. For example, a communication network device may include two or more wired or wireless communication devices (e.g., as part of a common integrated circuit such as a system-on-a-chip, on a common circuit board, etc.). For example, the communication network device may include a PLC device for powerline communication and a WLAN device for WLAN communication. If the powerline interference analyzer 112 determines that the PLC medium is subject to a large number of noise sources and that the noise encountered in the powerline network 102 cannot be eliminated, the communication network device can determine to route communications via a WLAN communication channel as opposed to the PLC medium.

Embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). A machine-readable medium may be a non-transitory machine-readable storage medium, or a transitory machine-readable signal medium. A machine-readable storage medium may include, for example, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of tangible medium suitable for storing electronic instructions. A machine-readable signal medium may include a propagated data signal with computer readable program code embodied therein, for example, an electrical, optical, acoustical, or other form of propagated signal (e.g., carrier waves, infrared signals, digital signals, etc.). Program code embodied on a machine-readable medium may be transmitted using any suitable medium, including, but not limited to, wireline, wireless, optical fiber cable, RF, or other communications medium.

Computer program code for carrying out operations of the embodiments may be written in any combination of one or more programming languages, including an object oriented programming language such as Java, Smalltalk, C++or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

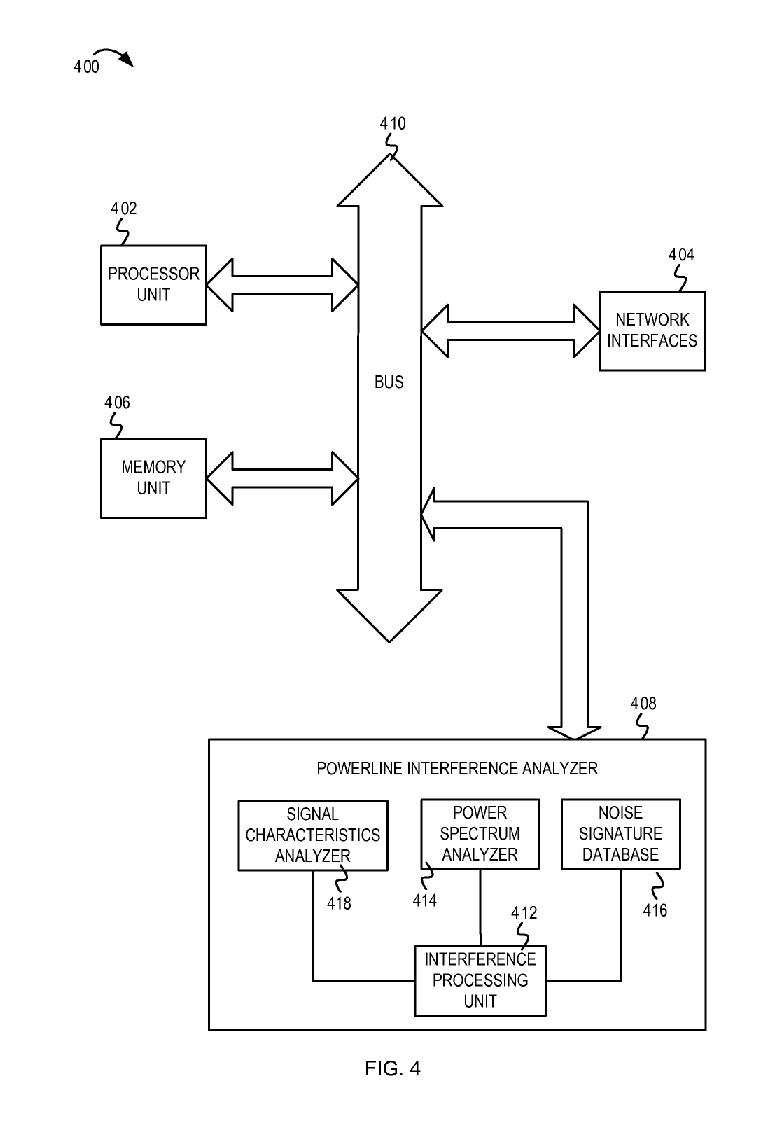

FIG. 4 is a block diagram of one embodiment of an electronic device 400 including a mechanism for interference detection in a powerline network. In some implementations, the electronic device 400 may be a personal computer (PC), a laptop, a netbook, a mobile phone, a personal digital assistant (PDA), a smart appliance, or other electronic systems configured to communicate across a wired network (e.g., a powerline network or an Ethernet network) or a wireless communication network (e.g., WLAN). The electronic device 400 includes a processor unit 402 (possibly including multiple processors, multiple cores, multiple nodes, and/or implementing multi-threading, etc.). The electronic device 400 includes a memory unit 406. The memory unit 406 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The electronic device 400 also includes a bus 410 (e.g., PCI, ISA, PCI-Express, HyperTransport , InfiniBand , NuBus, AHB, AXI, etc.), and network interfaces 404 that include at least one wired network interface (e.g., a powerline communication interface) or a wireless network interface (e.g., a WLAN interface, a Bluetooth® interface, a WiMAX interface, a ZigBee® interface, a Wireless USB interface, etc.).

The electronic device 400 also includes a powerline interference analyzer 408. The powerline interference analyzer 408 comprises an interference processing unit 412 coupled to a power spectrum analyzer 414, a noise signature database 416, and a signal characteristics analyzer 418. As described above with reference to FIGS. 1-2, the powerline interference analyzer 408 can implement functionality to analyze noise characteristics of a powerline network to which the electronic device 400 is connected and determine noise patterns in the powerline network noise characteristics. As described above with reference to FIGS. 1-3, the powerline interference analyzer 408 can also implement functionality to analyze signal characteristics of received powerline communication signals and to determine the noise patterns based on analyzing the signal characteristics. Based on the noise signature database 416, the powerline interference analyzer 408 can identify devices or classes of devices (associated with the noise patterns) in the powerline network that could potentially be degrading communication performance of the electronic device 400. The powerline interference analyzer 408 can also present suggestions for minimizing the effect of noise/interference/attenuation generated by the identified devices.

It should be noted that any one of the above-described functionalities might be partially (or entirely) implemented in hardware and/or on the processor unit 402. For example, the functionality may be implemented with an application specific integrated circuit, in logic implemented in the processor unit 402, in a co-processor on a peripheral device or card, etc. Further, realizations may include fewer or additional components not illustrated in FIG. 4 (e.g., additional network interfaces, peripheral devices, etc.). The processor unit 402 and the network interfaces 404 are coupled to the bus 410. Although illustrated as being coupled to the bus 410, the memory unit 406 may be coupled to the processor unit 402. Furthermore, in some implementations, the powerline interference analyzer 408 can be implemented on a separate chip, a system on a chip (SoC), an application-specific integrated circuit (ASIC), etc., distinct from the electronic device 400 and externally coupled to the electronic device 400.

While the embodiments are described with reference to various implementations and exploitations, it will be understood that these embodiments are illustrative and that the scope of the inventive subject matter is not limited to them. In general, techniques for interference detection in a powerline communication network as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
determining, at a powerline interference analyzer, powerline network noise characteristics that are representative of noise on a powerline communication network;
determining, at the powerline interference analyzer, one or more noise patterns based on analyzing the powerline network noise characteristics;
comparing the one or more noise patterns with a plurality of predefined noise signatures stored in the powerline interference analyzer that are representative of corresponding each of a plurality of noise sources;
identifying at least one noise source, from the plurality of the noise sources stored in the powerline interference analyzer, that is associated with the one or more noise patterns based on said comparing the one or more noise patterns with the plurality of predefined noise signatures; and
presenting an indication of the at least one noise source from the plurality of the noise sources that is associated with the one or more noise patterns.

2. The method of claim 1, wherein the powerline network noise characteristics comprise at least one of a frequency domain representation of the noise on the powerline communication network, a time domain representation of the noise on the powerline communication network, attenuation characteristics of the powerline communication network, distortion characteristics of the powerline communication network, and interference associated with the powerline communication network.

3. The method of claim 1, wherein said determining the powerline network noise characteristics that are representative of noise on the powerline communication network further comprises:
determining, at the powerline interference analyzer, a time interval during which to analyze the powerline network noise characteristics; and
collecting one or more noise measurements to determine the powerline network noise characteristics during the time interval.

4. The method of claim 3, wherein the time interval during which to analyze the powerline network noise characteristics comprises at least one of:
a predetermined time interval wherein communications of powerline communication devices connected to the powerline communication network are prevented;
an idle time interval wherein the powerline interference analyzer detects an absence of communications of the powerline communication devices connected to the powerline communication network; and
an inter-frame time interval between subsequent communications of the powerline communication devices connected to the powerline communication network.

5. The method of claim 1, wherein said determining the powerline network noise characteristics that are representative of noise on the powerline communication network further comprises:
receiving, at the powerline interference analyzer, one or more powerline communication signals from one or more powerline communication devices connected to the powerline communication network;
determining, at the powerline interference analyzer, signal characteristics associated with the one or more powerline communication signals; and
determining the powerline network noise characteristics based, at least in part, on the signal characteristics associated with the one or more powerline communication signals.

6. The method of claim 5, wherein said determining the one or more noise patterns based on analyzing the powerline network noise characteristics comprises:
determining whether measurements of the signal characteristics associated with the one or more powerline communication signals periodically violate threshold measurement values of the signal characteristics; and
determining the one or more noise patterns based on determining a variation of the measurements of the signal characteristics associated with the one or more powerline communication signals.

7. The method of claim 6, wherein the measurements of the signal characteristics associated with the one or more powerline communication signals are determined within a plurality of consecutive predefined time intervals.

8. The method of claim 5,
wherein said determining the signal characteristics associated with the one or more powerline communication signals comprises determining a signal-to-noise ratio associated with the one or more powerline communication signals, and
wherein said determining the one or more noise patterns based on analyzing the powerline network noise characteristics comprises:
determining whether the signal-to-noise ratio associated with the one or more powerline communication signals periodically falls below a threshold signal-to-noise ratio; and
determining the one or more noise patterns based on determining a variation of the signal-to-noise ratio associated with the one or more powerline communication signals.

9. The method of claim 5, wherein the signal characteristics associated with the one or more powerline communication signals comprises at least one of a signal to noise ratio associated with each of the one or more powerline communication signals, a signal strength associated with each of the one or more powerline communication signals, an automatic gain control (AGC) level applied to each of the one or more powerline communication signals, a data rate associated with each of the one or more powerline communication signals, and a bit error rate associated with each of the one or more powerline communication signals.

10. The method of claim 1, wherein the one or more noise patterns comprise at least one of a time-variation of the powerline network noise characteristics, a frequency-variation of the powerline network noise characteristics, and an AC cycle-variation of the powerline network noise characteristics.

11. The method of claim 1, wherein the at least one noise source is at least one electronic device coupled with the powerline communication network or at least one wireless communication device in the vicinity of the powerline communication network.

12. The method of claim 1, wherein said identifying the at least one noise source, from the plurality of the noise sources stored in the powerline interference analyzer, that is associated with the one or more noise patterns further comprises:
determining that the one or more noise patterns matches at least one noise signature of the plurality of predefined noise signatures based on said comparing the one or more noise patterns with the plurality of predefined noise signatures stored in the powerline interference analyzer that are representative of corresponding each of the plurality of noise sources; and
determining the at least one noise source that is associated with the at least one noise signature of the plurality of predefined noise signatures that matches the one or more noise patterns.

13. The method of claim 1, further comprising:
identifying one or more techniques for mitigating the effect of the at least one noise source that is associated with the one or more noise patterns.

14. The method of claim 13, wherein said presenting the indication of the at least one noise source from the plurality of the noise sources that is associated with the one or more noise patterns further comprises:
indicating the one or more techniques for mitigating the effect of the at least one noise source.

15. The method of claim 1, wherein said presenting the indication of the at least one noise source from the plurality of the noise sources that is associated with the one or more noise patterns comprises at least one of:
presenting the indication of the at least one noise source on a display unit coupled with the powerline interference analyzer,
presenting the indication of the at least one noise source on a computer system coupled with the powerline interference analyzer, and
presenting the indication of the at least one noise source on a website.

16. A communication network device comprising:
a processor;
a network interface coupled with the processor; and
a powerline interference analyzer coupled with the processor and the network interface, the powerline interference analyzer operable to:
determine powerline network noise characteristics that are representative of noise on a powerline communication network;
determine one or more noise patterns based on analyzing the powerline network noise characteristics;
compare the one or more noise patterns with a plurality of predefined noise signatures stored in a noise signature database associated with the powerline interference analyzer that are representative of corresponding each of a plurality of noise sources;
identify at least one noise source, from the plurality of the noise sources stored in the noise signature database, that is associated with the one or more noise patterns based on the powerline interference analyzer comparing the one or more noise patterns with the plurality of predefined noise signatures; and
present an indication of the at least one noise source from the plurality of the noise sources that is associated with the one or more noise patterns.

17. The communication network device of claim 16, wherein the powerline network noise characteristics comprise at least one of a frequency domain representation of the noise on the powerline communication network, a time domain representation of the noise on the powerline communication network, attenuation characteristics of the powerline communication network, distortion characteristics of the powerline communication network, and interference associated with the powerline communication network.

18. The communication network device of claim 16, wherein the powerline interference analyzer operable to determine the powerline network noise characteristics that are representative of noise on the powerline communication network further comprises the powerline interference analyzer operable to:
receive one or more powerline communication signals from one or more powerline communication devices connected to the powerline communication network;
determine signal characteristics associated with the one or more powerline communication signals; and
determine the powerline network noise characteristics based, at least in part, on the signal characteristics associated with the one or more powerline communication signals.

19. The communication network device of claim 18, wherein the powerline interference analyzer operable to determine the one or more noise patterns based on analyzing the powerline network noise characteristics comprises the powerline interference analyzer operable to:
determine whether measurements of the signal characteristics associated with the one or more powerline communication signals periodically violate threshold measurement values of the signal characteristics; and
determine the one or more noise patterns based on determining a variation of the measurements of the signal characteristics associated with the one or more powerline communication signals.

20. The communication network device of claim 16, wherein the signal characteristics associated with the one or more powerline communication signals comprises at least one of a signal to noise ratio associated with each of the one or more powerline communication signals, a signal strength associated with each of the one or more powerline communication signals, an automatic gain control (AGC) level applied to each of the one or more powerline communication signals, a data rate associated with each of the one or more powerline communication signals, and a bit error rate associated with each of the one or more powerline communication signals

21. The communication network device of claim 16, wherein the powerline interference analyzer operable to identify the at least one noise source, from the plurality of the noise sources stored in the noise signature database, that is associated with the one or more noise patterns further comprises the powerline interference analyzer operable to:
determine that the one or more noise patterns matches at least one noise signature of the plurality of predefined noise signatures based on powerline interference analyzer comparing the one or more noise patterns with the plurality of predefined noise signatures stored in the noise signature database that are representative of corresponding each of the plurality of noise sources; and
determine the at least one noise source that is associated with the at least one noise signature of the plurality of predefined noise signatures that matches the one or more noise patterns.

22. The communication network device of claim 16, wherein powerline interference analyzer operable to present the indication of the at least one noise source from the plurality of the noise sources that is associated with the one or more noise patterns further comprises powerline interference analyzer operable to:
identify one or more techniques for mitigating the effect of the at least one noise source that is associated with the one or more noise patterns; and
indicate the one or more techniques for mitigating the effect of the at least one noise source.

23. One or more machine-readable storage media having instructions stored therein, which when executed by one or more processor units causes the one or more processor units to perform operations that comprise:
determining, at a powerline interference analyzer, powerline network noise characteristics that are representative of noise on a powerline communication network;
determining one or more noise patterns based on analyzing the powerline network noise characteristics;
comparing the one or more noise patterns with a plurality of predefined noise signatures stored in the powerline interference analyzer that are representative of corresponding each of a plurality of noise sources;
identifying at least one noise source, from the plurality of the noise sources stored in the powerline interference analyzer, that is associated with the one or more noise patterns based on comparing the one or more noise patterns with the plurality of predefined noise signatures; and
presenting an indication of the at least one noise source from the plurality of the noise sources that is associated with the one or more noise patterns.

24. The machine-readable storage media of claim 23, wherein said operation of determining the powerline network noise characteristics that are representative of noise on the powerline communication network further comprises:
determining a time interval during which to analyze the powerline network noise characteristics; and
collecting one or more noise measurements to determine the powerline network noise characteristics during the time interval.

25. The machine-readable storage media of claim 23, wherein said operation of determining the powerline network noise characteristics that are representative of noise on the powerline communication network further comprises:
receiving one or more powerline communication signals from one or more powerline communication devices connected to the powerline communication network;
determining signal characteristics associated with the one or more powerline communication signals; and
determining the powerline network noise characteristics based, at least in part, on the signal characteristics associated with the one or more powerline communication signals.

26. The machine-readable storage media of claim 23, wherein said operation of presenting the indication of the at least one noise source from the plurality of the noise sources that is associated with the one or more noise patterns further comprises:
identifying one or more techniques for mitigating the effect of the at least one noise source that is associated with the one or more noise patterns; and
indicating the one or more techniques for mitigating the effect of the at least one noise source.
